(19) United States
(12) Patent Application Publication
(10) Pub. No.: US 2013/0045707 A1
(43) Pub. Date: Feb. 21, 2013

(54) APPARATUS AND METHOD FOR TRANSMITTING AN EMERGENCY CALL IN A PORTABLE TERMINAL

(71) Applicants: Shin-Duck LEE, Gyeongsangbuk-do (KR); Hyun-Chul LEE, Daegu (KR)

(72) Inventors: Shin-Duck LEE, Gyeongsangbuk-do (KR); Hyun-Chul LEE, Daegu (KR)

(73) Assignee: SAMSUNG ELECTRONICS CO., LTD., Gyeonggi-do (KR)

(21) Appl. No.: 13/589,791

(22) Filed: Aug. 20, 2012

(30) Foreign Application Priority Data
Aug. 19, 2011 (KR) 10-2011-0082763

(51) Int. Cl. H04W 4/22

(52) U.S. Cl. 455/404.1

(57) ABSTRACT

A method and apparatus for transmitting an emergency call in a portable terminal includes determining whether an emergency call through a currently executed first radio access technology (RAT) is available when the emergency call is requested, selecting a second RAT from among a plurality of RATs supported by the portable terminal when the transmission of the emergency call is unavailable, determining whether transmission of the emergency call through the second RAT is available, and if so, transmitting the emergency call through the second RAT.

### CLAIM OF PRIORITY

This application claims the priority under 35 U.S.C. §119(a) of an application entitled “Apparatus And Method For Transmitting An Emergency Call In A Portable Terminal” filed in the Korean Intellectual Property Office on Aug. 19, 2011 and assigned Serial No. 10-2011-0082763, the contents of which are hereby incorporated by reference.

### BACKGROUND OF THE INVENTION

1. Field of the Invention

The present invention relates to a portable terminal, and more particularly, to a method and apparatus for transmitting an emergency call in a portable terminal

2. Description of the Related Art

A multiple radio access technology (multi-RAT) refers to a part of a mobile Telecommunication system that supports one or more RATs schemes used to allow multiple users to access the cellular system, for example, a Global System for Mobile Telecommunication (GSM) system corresponding to a second generation mobile communication system utilized in Europe and the like, a Universal Mobile Telecommunication System (UMTS) system corresponding to a third generation mobile communication system, and a Long Term Evolution (LTE) system corresponding to a fourth generation mobile communication system.

Although the multi-RAT is supported, one of RATs supported by the multi-RAT may be fixed for a portable terminal, for example, 3G system, to provide a communication service. Thus, there is a drawback in that the portable terminal may not transmit an emergency call when a communication service through the fixed RAT is unavailable as the RAT cannot be connected simultaneously to multiple radio access technologies, i.e., both 3G and 4G systems

Accordingly, there is a need for an improved method to transmit an emergency call when the fixed RAT is incapable of transmitting the emergency call.

### SUMMARY OF THE INVENTION

Accordingly, an aspect of the present invention is to solve the above-mentioned problems occurring in the prior art, and to provide a method and apparatus for transmitting an emergency call through another RAT when transmission of the emergency call through a fixed RAT is unavailable.

In accordance with an aspect of the present invention, there is provided an apparatus for transmitting an emergency call using a portable terminal, the apparatus including a transceiver to transmit an emergency call, and a controller to determine whether transmission of an emergency call through a currently executed first radio access technology (RAT) is available when the emergency call is requested, to select a second RAT from among a plurality of RATs supported by the portable terminal when the transmission of the emergency call is unavailable, to determine whether transmission of the emergency call through the second RAT is available, and to transmit the emergency call through the second RAT when the transmission of the emergency call is available.

In accordance with another aspect of the present invention, there is provided a method of transmitting an emergency call in a portable terminal, the method including determining whether transmission of an emergency call through a currently executed first RAT is available when the emergency call is requested, selecting a second RAT from among a plurality of RATs supported by the portable terminal when the transmission of the emergency call is unavailable, determining whether transmission of the emergency call through the second RAT is available, and transmitting the emergency call through the second RAT when the transmission of the emergency call is available.

Exemplary embodiments may provide an effect of transmitting an emergency call through another RAT when transmission of the emergency call through a fixed RAT is unavailable.

### BRIEF DESCRIPTION OF THE DRAWING

The above and other aspects, features and advantages of the present invention will be more apparent from the following detailed description taken in conjunction with the accompanying drawings, in which:

FIG. 1 is a diagram illustrating a configuration of a radio communication system according to an exemplary embodiment of the present invention;

FIG. 2 is a block diagram illustrating a configuration of a portable terminal according to an exemplary embodiment of the present invention; and

FIG. 3 is a flowchart illustrating a method of transmitting an emergency call in a portable terminal according to an exemplary embodiment of the present invention.

### DETAILED DESCRIPTION

Hereinafter, exemplary embodiments of the present invention will be described with reference to the accompanying drawings. In the following description, the same elements will be designated by the same reference numerals although they are shown in different drawings. Further, various specific definitions found in the following description, such as specific values of packet identifications, contents of displayed information, etc., are provided only to help general understanding of the present invention, and it is apparent to those skilled in the art that the present invention can be implemented without such definitions. For the purposes of clarity and simplicity, a detailed description of known functions and configurations incorporated herein will be omitted as it may make the subject matter of the present invention rather unclear.

A portable terminal according to an exemplary embodiment may be a portable electronic device or a user equipment (UE), for example, a videophone, a portable phone, a smart phone, an International Mobile Telecommunication 2000 (IMT-2000) terminal, a Wideband Code Division Multiple Access (WCDMA) terminal, a Universal Mobile Telecommunication Service (UMTS) terminal, a Personal Digital Assistance (PDA), a Portable Multimedia Player (PMP), a Digital Multimedia Broadcasting (DMB) terminal, an E-book, portable computers including a notebook, a tablet, and the like, a digital camera, and the like. Among the terms set forth herein, a terminal refers to any kind of device capable of processing data which is transmitted or received to or from any external entity.

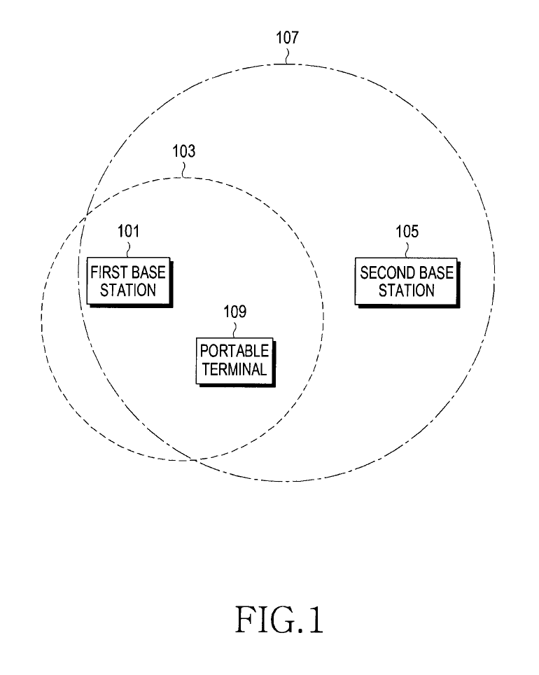

FIG. 1 illustrates a configuration of a radio communication system according to an exemplary embodiment of the present invention.

Referring to FIG. 1, the radio communication system may include a first base station 101, a second base station 105, and a portable terminal 109.

As shown, the first base station 101 may provide a first cell area 103, and the second base station 105 may provide a second cell area 105. The first base station 101 and the second base station 105 may support different radio access technologies (RATs), and may communicate with the portable terminal 109 through a radio link.

For example, the first base station 101 may support UMTS which is one of the RATs, and the second base station 105 may support Global System for Mobile Communication (GSM) which is another one of the RATs. As another example, the second base station 105 may support Long Term Evolution (LTE) which is yet another one of the RATs. Here, GSM is a second generation radio communication system, UMTS is a third generation radio communication system, and LTE is a fourth generation radio communication system.

The portable terminal 109 may provide a communication service through one of the RATs supported by the multi-RAT. For example, the portable terminal 109 may provide a communication service based on UMTS that supports a packet service (PS), from among RATs including GSM and UMTS.

In operation, when a user requests transmission of an emergency call while a communication service is provided through a fixed RAT, the portable terminal 109 may determine whether the communication service is available through the fixed RAT that is currently being used for the communication service. When the provision of the communication service is unavailable, the portable terminal 109 may search for another RAT that is capable of performing the communication service, and then transmit the emergency call through the retrieved RAT, so as to process the emergency call.

The portable terminal 109 may selectively choose an RAT so as to support a communication service for the portable terminal 109. For example, when the fixed RAT is UMTS, the portable terminal 109 may provide a communication service through the first base station 101 that supports a UMTS scheme. As another example, when the fixed RAT is LTE, the portable terminal 109 may provide a communication service through the second base station 105 that supports an LTE scheme.

That is, when the transmission of the emergency call is requested, the portable terminal 109 may determine whether a cell associated with the fixed RAT exists in a current location of the portable terminal 109. When the cell associated with the fixed RAT exists, the portable terminal 109 may determine that provision of a communication service through the fixed RAT is available, and may transmit the emergency call through the fixed RAT.

For example, when the fixed RAT is UMTS, the portable terminal 109 may determine whether the portable terminal 109 is located in a first cell 103 of the first base station 101 that supports UMTS. Here, the portable terminal 109 is programmed to periodically searches adjacent cells for synchronization. Thus, when the portable terminal 109 is located in the first cell 103 and the synchronization is successful, the portable terminal 109 may transmit an emergency call to the first base station 101 supporting UMTS.

Conversely, when the cell associated with the fixed RAD does not exist, the portable terminal 109 may determine that the provision of the communication service through the fixed RAT is unavailable, and then may change the fixed RAT to another RAT. For example, when the fixed RAT is UMTS and the portable terminal 109 is not located in the first cell 103, the portable terminal 109 may change the fixed RAT from UMTS to LTE.

For example, when the fixed RAT is UMTS, the other RAT may be LTE or GSM. As another example, when the fixed RAT is LTE, the other RAT may be UMTS or GSM.

Thereafter, the portable terminal 109 may determine whether a cell associated with the changed RAT exists in the current location of the portable terminal 109. To this end, the portable terminal 109 searches and try to synchronize with the cell using a changed RAT. When the cell associated with the changed RAT exists, the portable terminal 109 may determine that provision of the communication service through the changed RAT is available and may transmit the emergency call through the changed RAT.

For example, when the changed RAT is LTE, the portable terminal 109 may determine whether the portable terminal 109 is located in the second cell 107 of the second base station 105 that supports LTE. When the portable terminal 109 is located in the second cell 107, the portable terminal 109 may transmit an emergency call to the second base station 105.

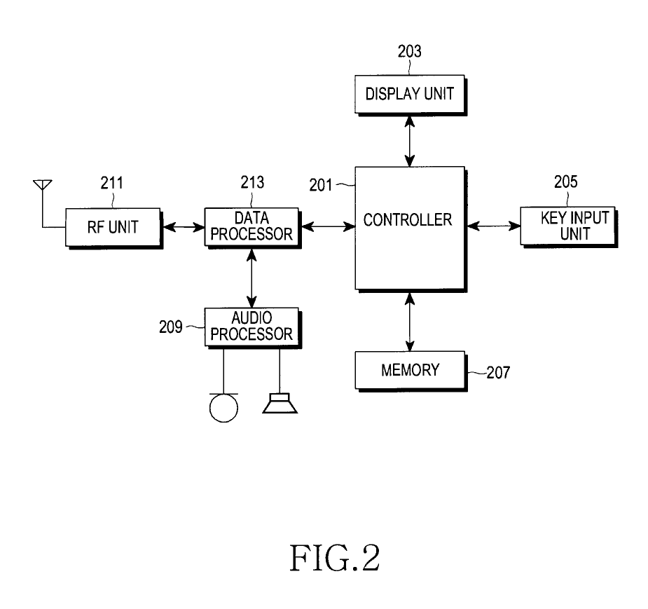

FIG. 2 illustrates a configuration of a portable terminal according to an exemplary embodiment of the present invention.

Referring to FIG. 2, the portable terminal may include a controller 201, a display unit 203, a key input unit 205, a memory 207, an audio processor 209, and a radio frequency (RF) unit 211, and a data processor 213.

The RF unit 211 may perform a radio communication function of the portable terminal. In particular, the RF unit 211 may include a wireless transmitter to perform up-conversion and amplification of a frequency of a transmitted signal, a wireless receiver to perform low noise amplification of a received signal and low-conversion of a frequency, and the like. The data processor 213 may include a transmitter to encode and modulate a transmitted signal, a receiver to demodulate and decode a received signal, and the like. Here, the data processor 213 may be configured to include a modem and a codec. The codec may include a data codec to process packet data and the like, and may include an audio codec to process an audio signal such as a voice and the like.

The audio processor 209 may play back, through a speaker, a reception audio signal output from the data processor 213, or may transmit a transmission audio signal generated from a microphone to the data processor 213. The key input unit 205 may include keys for inputting number and character information, and functional keys for setting varied types of functions. The display unit 203 may display an image signal on a screen, and may display data that is requested by the controller 201.

When the display unit 203 is implemented with a touch display screen, for example, a capacitive touch screen, a resistive touch screen, or the like. The key input unit 205 may include predetermined keys at the minimum, and the display unit 203 may be substituted for a part of a key input function of the key input unit 205.

The memory 207 may include a program memory and a data memory. Here, the program memory may store a boot and operating system (OS) for controlling a general operation of the portable terminal, and the data memory may store various data generated while the portable terminal operates.

The controller 201 may perform a function of controlling the general operation of the portable terminal Particularly, when transmission of an emergency call is requested by a user while a communication service is provided through a fixed RAT, the controller 201 may determine whether provision of the communication service is available through the fixed RAT that is currently used. When the provision of the communication service is unavailable, the controller 201 may search for another RAT that is capable of providing the communication service, and may transmit the emergency call through the retrieved RAT so as to process the emergency call.

More particularly, the controller 201 may fix one of the RATs supported by a multi-RAT so as to provide the communication service through the fixed RAT, and may support the communication service of the portable terminal through the fixed RAT. For example, when the fixed RAT is UMTS, the controller 201 may support the communication service through a UMTS network. As another example, when the fixed RAT is LTE, the controller 201 may support the communication service through an LTE network.

The controller 201 may determine whether transmission of an emergency call is requested by the user. When the emergency call is requested, the controller 201 may determine whether a cell associated with the fixed RAT exists in a current location of the portable terminal.

As a result of the determination, when the cell associated with the fixed RAT exists, the controller 201 may determine that the provision of the communication service through the fixed RAT is available, and may transmit the emergency call through the fixed RAT. In contrast, when the cell associated with the fixed RAT does not exist, the controller 201 may determine that the provision of the communication service through the fixed RAT is unavailable, and may change the fixed RAT to another RAT. Here, the other RAT may be an RAT different from the fixed RAT. For example, when the fixed RAT is UMTS, the other RAT may be LTE or GSM.

The controller 201 may determine whether a cell associated with the changed RAT exists in the current location of the portable terminal. When the cell associated with the changed RAT exists, the controller 201 may determine that provision of the communication service through the changed RAT is available, and may transmit the emergency call through the changed RAT.

For example, when the fixed RAT is UMTS, the controller 201 may determine whether the portable terminal 109 is located in the first cell 103 of the first base station 101 that supports UMTS. When the portable terminal 109 is located in the first cell 103, the controller 201 may transmit an emergency call to the first base station 101.

Conversely, when the portable terminal 109 does not exist in the first cell 103, the controller 201 may change the fixed RAT from UMTS to LTE. The controller 201 may determine whether the portable terminal 109 is located in the second cell 107 of the second base station 105 that supports LTE. When the portable terminal 109 is located in the second cell 107, the controller 201 may transmit an emergency call to the second base station 105 that supports LTE.

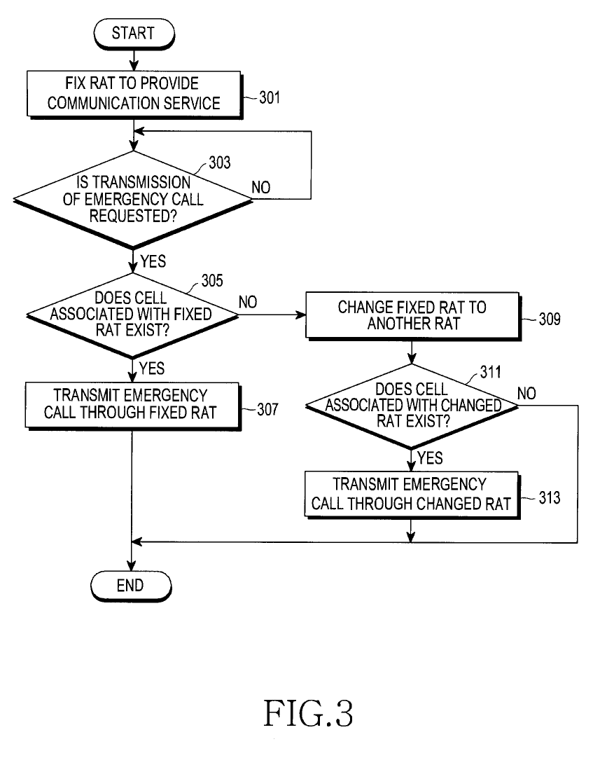

FIG. 3 illustrates a method of transmitting an emergency call in a portable terminal according to an exemplary embodiment of the present invention.

Referring to FIG. 3, in operation 301, the controller 201 may select one of the RATs supported by a multi-RAT of the portable terminal, may fix the selected RAT, may provide a communication service of the portable terminal through the fixed RAT, and may proceed with operation 303. For example, when the fixed RAT is UMTS, the controller 201 may support the communication service through a UMTS scheme. Alternatively, when the fixed RAT is LTE, the controller 201 may support the communication service through an LTE scheme.

In operation 303, the controller 201 may determine whether transmission of an emergency call is requested by a user. When the transmission of the emergency call is requested by the user, the controller 201 may proceed with operation 305. Otherwise, the controller 201 may repeatedly perform operation 303.

When the controller 201 proceeds with operation 305, the controller 201 may determine whether a cell associated with the fixed RAT exists in a current location of the portable terminal. For example, in case that the fixed RAT is the 3G communication system, a portable terminal exists in the cell of the 3G communication system. To this end, the controller periodically searches adjacent cells and performs a synchronization with the searched cell. Therefore, if the cell search for the fixed RAT is not performed, the controller determines that the cell does not exist.

When the cell associated with the fixed RAT exists, the controller 201 may proceed with operation 307. Otherwise, the controller 201 may proceed with operation 309. When the controller 201 proceeds with operation 307, the controller 201 may determine that provision of the communication service through the fixed RAT is available, and may transmit the emergency call through the fixed RAT. Here, the controller determines that if there exists the cell for the RAT fixed in the current location of the terminal.

Conversely, when the controller 201 proceeds with operation 309, the controller 201 may determine that the provision of the communication service through the fixed RAT is unavailable, and may change the fixed RAT to another RAT and may proceed with operation 311. For example, when the fixed RAT is UMTS, the new RAT may be LTE or GSM.

In operation 311, the controller 201 may determine whether a cell associated with the changed RAT exists in the current location of the portable terminal. When the cell associated with the changed RAT exists, the controller 201 may proceed with operation 313. Otherwise, a process of transmitting an emergency call may be terminated.

In operation 313, the controller 201 may determine that the provision of the communication service through the changed RAT is available, and may transmit the emergency call through the changed RAT.

Through the operations described in the foregoing, the present invention may provide an effect of transmitting an emergency call through another RAT when transmission of the emergency call through a fixed RAT is unavailable.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An apparatus for transmitting an emergency call via a portable terminal, the apparatus comprising:
a transceiver to transmit an emergency call; and
a controller to determine whether transmission of an emergency call through a currently executed first radio access technology (RAT) is available when the emergency call is requested; to select a second RAT from among a plurality of RATs supported by the portable terminal when the transmission of the emergency call is unavailable; and to determine whether the transmission of the emergency call through the second RAT is available for a subsequent transmission.

2. The apparatus of claim 1, wherein the controller determines whether the portable terminal exists in a cell area of a first base station that supports the first RAT, so as to determine whether the emergency call through the first RAT is available.

3. The apparatus of claim 1, wherein the controller determines whether the portable terminal exists in a cell area of a second base station that supports the second RAT, so as to determine whether the transmission of the emergency call through the second RAT is available.

4. The apparatus of claim 1, wherein the first RAT is one of technologies including Global System for Mobile Telecommunications (GSM), Universal Mobile Telecommunication System (UMTS), and Long Term Evolution (LTE).

5. The apparatus of claim 1, wherein the second RAT is one of technologies including Global System for Mobile Telecommunication (GSM), Universal Mobile Telecommunication System (UMTS), and Long Term Evolution (LTE).

6. A method of transmitting an emergency call via a portable terminal, the method comprising:
determining whether transmission of an emergency call through a currently executed first radio access technology (RAT) is available when the emergency call is requested;
selecting a second RAT from among a plurality of RATs supported by the portable terminal when the transmission of the emergency call is unavailable via the first RAT; and
determining whether transmission of the emergency call through the second RAT is feasible for a subsequent transmission.

7. The method of claim 6, wherein determining of whether transmission of the emergency call through the first RAT is available comprises:
determining whether the portable terminal exists in a cell area of a first base station that supports the first RAT.

8. The method of claim 6, wherein determining of whether transmission of the emergency call through the second RAT is available comprises:
determining whether the portable terminal exists in a cell area of a second base station that supports the second RAT.

9. The method of claim 6, wherein the first RAT is one of technologies including Global System for Mobile Telecommunication (GSM), Universal Mobile Telecommunication System (UMTS), and Long Term Evolution (LTE).

10. The method of claim 6, wherein the second RAT is one of technologies including Global System for Mobile Telecommunication (GSM), Universal Mobile Telecommunication System (UMTS), and Long Term Evolution (LTE).
